(19) United States
(12) Patent Application Publication
(10) Pub. No.: US 2005/0250081 A1
(43) Pub. Date: Nov. 10, 2005

(54) Method and system for human personal trait analysis

(76) Inventor: Timothy L. Salladay, Dallas, TX (US)

Correspondence Address: FISH & RICHARDSON P.C., 1717 MAIN STREET, SUITE 5000, DALLAS, TX, 75201, US

(21) Appl. No.: 11/118,581

(22) Filed: Apr. 29, 2005

Related U.S. Application Data
(60) Provisional application No. 60/566,847, filed on Apr. 29, 2004.

(51) Int. Cl. G09B 19/00

(52) U.S. Cl. 434/236

(57) ABSTRACT

A method and system for human personal and organizational source and trait analysis is disclosed. Pursuant to the present invention, testing of an individual or organization is based according to three general areas: ideas (thinking); emotions (feeling); and actions (doing). The system and method assigns colors to each of these areas: yellow for ideas; blue for emotions; and red for actions. Utilizing the system and method of the present invention, traits such as self-esteem, motives, skills, goals, aesthetics and clarity of an individual or organization are analyzed to provide a more complete picture of the individual or organization.

### CROSS-REFERENCE TO RELATED APPLICATIONS

This application is related to and claims the benefit of priority to co-pending provisional application Ser. No. 60/566,847, filed Apr. 29, 2004, entitled Method and System for Human Personal Trait Analysis, which is incorporated herein by reference.

### TECHNICAL FIELD

This invention relates to trait analysis, and more particularly to a method and system for human personal and organizational trait analysis.

### BACKGROUND

Psychology has a long tradition of scientific research on human behavior and personality. Through this research, a multitude of psychological assessment scales have been developed to objectively and precisely measure various aspects of psychological functioning and personality characteristics or traits. Traditionally, theorists such as Sigmund Freud and others argued that personality arises through social interactions, beginning even before birth between a mother and child. The results of such personality assessments are used for a variety of purposes, including, without limitation, employment, education, research, training, clinical treatment, and the like.

Generally, psychologists have identified a number of personality traits that are believed to be present in all people. Traits are considered to be the relatively enduring aspects of our personality that can be used to predict how we will behave in the future. Personality is the unique constellation of psychological traits and states of an individual. Combinations of these personality traits produce the vast range of individual differences evidenced among people.

Personality traits can reveal many interesting characteristics of an individual. For example, they can predict: (a) the coping skills of an individual; (b) the likelihood that an individual has the temperament required by a particular profession (e.g., police officer or pilot); (c) the diagnosis and/or best course of treatment for an individual to address clinical issues; and (d) the best approach at training an individual to complete a task or acquire/alter a social skill set (e.g., increase sensitivity to minorities). Such traits are even used by some to gauge creditworthiness and personal compatibility. Recent events affecting the fundamental security, or at least the perception of security, of the human race have only heightened the desire for personality trait information and use of same.

Testing or assessment of such personality traits is an important undertaking and is the focus of a large and growing industry. Some tests are designed to describe personality differences among what is believed to be “normal” or “average” individuals, while others are designed to identify abnormal personality traits. Still others are designed to identify specific “personality disorders” according to diagnostic characteristics.

Trait approach has brought refinement to personality measurement and testing. Techniques such as interviews, questionnaires and test are routinely employed to measure traits that are predictive of personality. Since each approach has associated, inherent limitations, many times combinations (e.g., testing and interview) of these approaches are utilized.

There exist many types of tests used in connection with discovering personality traits. Cognitive tests (those testing memory, intelligence, achievement and the like) are presumed to have little to do with personality, but, in combination with other tests, can be good predictors of traits of individuals. Using objective, or “standardized”, tests, an individual's responses to standard questions are compared to answers given by certain groups of individuals to see under what “class(es)” of individual(s) they fall. Projective tests (based at least in part on the Freudian concept of projection) employ questions that attempt to discover the unconscious tendency for an individual to project characteristics/attitudes about oneself onto others.

Regardless of the testing employed, most testing since the early 1900's has been based upon the “four quadrants” model. Carl Jung's work, “The Psychological Types,” published in 1921, provides the basis for such models. However, there are significant drawbacks associated with four quadrant-based models. For example, such models include the use of forced-choice formats (strengths/weaknesses). Under such formats, responses cannot be simultaneously weighed, varied, balanced, divergent and ambivalent.

As a result, the overall picture of the individual being tested is incomplete. Additionally, such models do not provide accurate pictures of organizational traits. Finally, under virtually all such “four-type” models, confusion has arisen as disputes over valid insight into values, behaviors, and thinking have been revealed.

There remains a need for a refinement of testing used to assess human personality and organizational traits and source utilization, such refinement capable of assessing the entire spectrum of experience and potential associated with an individual and/or an organization.

### SUMMARY

The present invention comprises a method and system for human personal and organizational trait analysis and source utilization. It is based in part upon two fundamental discoveries: (a) all subjects draw from three primary sources for traits; and (b) not every subject can be reduced to a “type” (as traditional four quadrant models attempt to do). For purposes of this application, the term “subject” will be used to refer to both individual humans and collections of humans, such as groups, teams and organizations.

Pursuant to the present invention, testing of a subject for trait identification and analysis is based according to three general source areas: thoughts, emotions and actions. The present invention system and method assigns colors to each of these areas: yellow for thinking; blue for feeling; and red for doing. These are known as “primary” colors. Utilizing the system and method of the present invention, traits like self-esteem, motives, skills, goals, aesthetics and clarity of an individual or organization are analyzed to provide a complete picture of the subject individual or organization. Additionally, the primary colors (and their associated areas) blend together to form the “secondary” colors of purple, orange and green. These secondary colors indicate certain “gifts” of the subject predicted by the blend of the associated areas.

Unlike traditional “four-quadrant”-based models, the present invention method and system is not complicated. It is in alignment with life experience and is therefore inherently intuitive. As a result, the present invention avoids some of the significant drawbacks associated with four quadrant-based models. For example, conventional four-quadrant-based models include the use of forced-choice formats (strengths/weaknesses). Under such formats, responses cannot be simultaneously weighed, varied, balanced, divergent and ambivalent. As a result, the overall picture of the subject being tested is incomplete. Additionally, traditional four quadrant-based models do not provide accurate pictures of organizational traits. The present invention addresses the various limitations and inaccuracies in conventional four-quadrant-based models and makes an allowance for ambivalence. Moreover, the present invention method and system avoids the confusion that has arisen as disputes over valid insight into values, behaviors, and thinking have been revealed in traditional four quadrant-type models. Importantly, the present invention system and method does not label a subject as a “type,” but, instead, identifies the three sources from which the subject draws traits to predict certain attributes and related concepts about the subject.

The three-source personal and organization feedback method and system of the present invention can be utilized in a number of ways. Such uses generally break down along personal and professional lines. On the personal side, the results can be used to provide: increased awareness of personal strengths (and weaknesses); improved self-esteem; specific insights for creating the personal mission statement; enhanced clarity and confidence with an emphasis on balance; relationship strategies; and assistance in raising and nurturing well-rounded children. In the workplace, the results can be used to provide: insights for hiring and placement decisions; strategies for performance improvement; next steps for leadership development; suggestions for minimizing conflict; exercises for team-building; and processes for enhancing sales and service skills.

The system allows subject surveys to be dynamically grouped (e.g., by individual, group or organization) to assist in comparisons of subject, whether they be individuals, teams and/or organizations.

Benefits associated with the present invention include:
an increased awareness of the strengths of individuals and of the organization;
a heightened appreciation for the gifts each person brings to a project;
discovering new strategies for balancing teams and the self for greater effectiveness;
a web-based system that can be administered anywhere, anytime;
a comprehensive, color report that can be printed at a desktop;
an intuitive concept that is easily transferred into a management competency;
a logical powerful approach that clarifies many conflicting systems;
a tool that easily and immediately applies to personal and professional areas of life; and
a system that helps teams connect well and enjoy working together.

Rather than attempting to label subjects as rigid “types,” the present invention identifies the sources (feeling, thinking, doing) from which all subjects draw to create their unique trait composition or “style.”

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a chart outlining the traits and gifts associated with the primary colors and the secondary colors, respectively, utilized by the present invention system and method;

FIG. 2 is a diagram showing the components of the system of the present invention;

FIG. 3 is a representative customized report model for “sales”; and

FIG. 4 is a flowchart showing the steps associated with the method of the present invention.

Like reference symbols in the various drawings indicate like elements.

### DETAILED DESCRIPTION

The present invention comprises a method and system for human personal and organizational trait analysis and source utilization. The present invention finds its roots in two fundamental discoveries: (a) all subjects draw from three primary sources for traits; and (b) not every subject can be reduced to a “type” (as traditional four quadrant models attempt to do). For purposes of this application, the term “subject” will be used to refer to both individual humans and collections of humans, such as groups, teams and organizations.

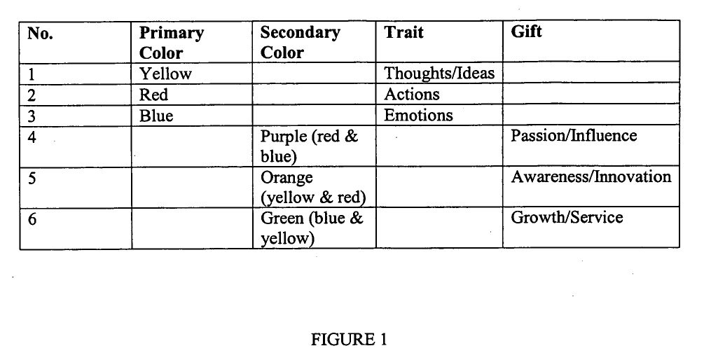

Pursuant to the present invention, testing of a subject, such as an individual or organization, is based upon the discovery that all traits are sourced from three general, or core, areas: ideas (thinking); emotions (feeling); and actions (doing). The present invention system and method assigns colors to each of these areas: yellow for ideas; blue for emotions; and red for actions. Known as “primary” colors, these colors (and their associated areas) blend together to form the “secondary” colors of purple, orange and green. Secondary colors indicate certain “gifts” that the blend of the associated colors/areas produce. For example, purple is formed from the blending of blue (ideas) and red (action), indicating an attribute of passion and the activity of influence. Similarly, the secondary color orange is produced by blending yellow (ideas) and red (actions), indicating an attribute of awareness and the activity of innovation. Finally, the secondary color green is produced by blending yellow (ideas) and blue (emotions), indicating the attribute of personal growth and the activity of service. FIG. 1 shows a chart outlining representative traits and associated color combinations.

As a subject provides information to the system in the form of responses to a series of questions or statements, the system analyzes the information based upon the three core areas and weighs the information in these three areas. A stronger weight in one area suggests a stronger trait for that subject. Each primary color has five levels of intensity from which the report draws. According to each response, the primary colors move to the center of the graphic forming the secondary colors and the center clear area.

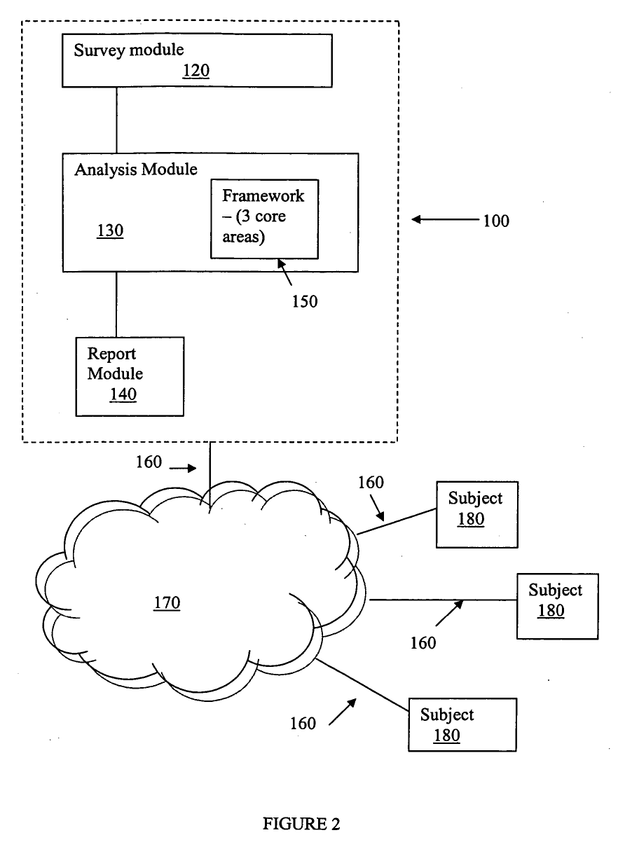

Now turning to FIG. 2, there is shown an illustration of the major components, or modules, of the present invention system 100. The system 100 is comprised of a survey module 120, an analysis module 130, and a report module 140. The analysis module 140 further comprises a framework 150 which is based upon three core areas, thoughts, emotions and actions.

The system 100 is preferably connected via communications means 160 to a global communications network 170, such as the Internet, to one or more subjects 180. In a preferred embodiment, the system 100 is provided in an application service provider context, where subjects 180 access the system 100 via one or more web presences (not shown), such as a web site on the Internet 170. Although an application server provider model is preferred, it is noted that the system 100 can be provided to subjects 180 in any number of ways, such as in the form of stand alone software, as a service bureau offering, or the like, if desired.

The subjects 180 utilize computers, personal digital assistants, telephones or any other suitable communications devices to access the system 100 via the communication means 160. Communication means 160 encompass any suitable means of providing access to the system 100, such as land lines, wireless communication networks, cable-based networks, satellite-based networks, servers, and the like.

The survey module 120 includes a list of queries or statements to which subjects 180 respond, for example, by providing an answer to a query or by indicating a level of affinity with a particular statement. The survey module 120 is designed to use a combination of queries and/or statements specifically customized to test for certain traits and/or gifts, as explained in additional detail below.

Once information (in the form of responses) is derived from the subject 180 by the survey module 120, the information is provided to the analysis module 130 of the system 100 for analysis. Analysis is performed on the information provided from the survey module 120 based upon three core areas: thinking; actions; and emotions. One advantage of the present invention over traditional models of trait analysis is that it is based upon the discovery that all subjects 180 draw from three primary sources, called “core areas” for purposes of this Application: thoughts, actions and emotions. All traits, gifts and similar attributes of a subject 180 ultimately can be resolved down to one of more of these core areas.

The analysis module 130 also assigns a primary color to each of the core areas: yellow for thoughts or ideas; red for actions; and blue for emotions so that information derived from the subject 180 can be analyzed to indicate the subject's strengths/weaknesses in the core areas. Each of these primary colors is further used to form blends, or “secondary colors” for purposes of this Application, to reveal “gifts” of the subject 180. Using this color scheme, the system 100 reduces the information provided by the survey module 120 down into the primary colors, and secondary colors, to identify the traits and associated with the subject 180.

Although a preferred embodiment of the present invention system and method uses the primary and secondary colors to identify traits (primary colors) and gifts (secondary colors) associated with a subject 180, it is noted that analysis of information from a subject 180 using the system 100 need not use a color scheme to identify such traits/gifts, if desired. The color scheme is used to provide a simple and intuitive visual display of the information and dramatically demonstrates the connections between certain core area strengths and gifts, and vice versa. Alternatively, the present invention could employ a color scheme based upon other colors, primary or otherwise, to accomplish the same results, as desired.

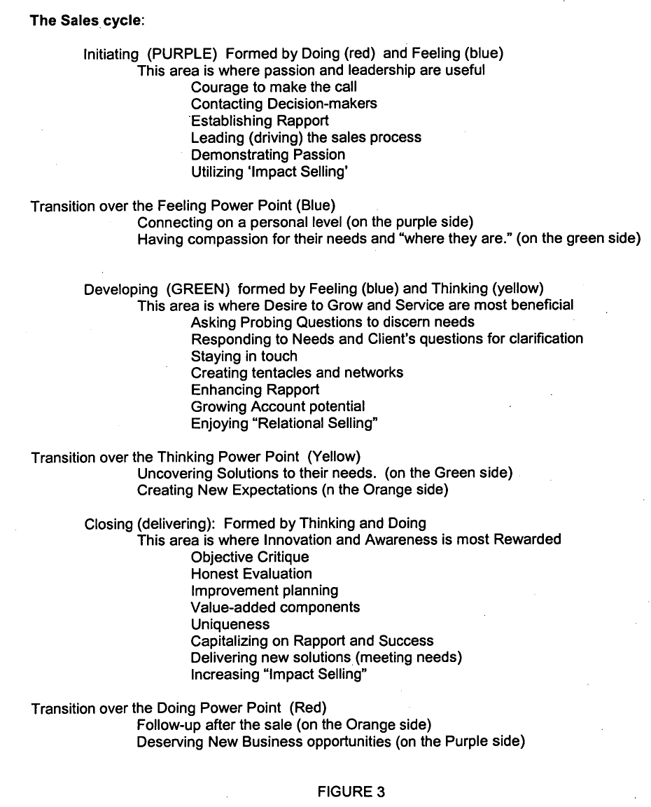

The report module 140 provides information and description of the traits and gifts identified by the system 100 about the subject 180. In a preferred embodiment, the report module 140 provides a real time report identifying the traits and/or gifts identified by the system 100 about the subject 180. Additionally, the report module can be customized to provide a report of the subject's traits as it relates to a specific area of interest, such as leadership, team, or sales. FIG. 3 illustrates a representative report module customized for sales.

In the representative report outlined in FIG. 3, critical components of the sales cycle is broken down into areas corresponding to the three core source areas of thinking, feeling and actions. The report uses the analysis of the subject's responses from the survey module to assign relative strengths to the major components of the sales process. For example, a subject with a strong purple score would indicate that the subject would have aptitude in initiating process of sales, likely to exhibit strength in the following related activities: courage to make the call; Contacting Decision-makers; Establishing Rapport; Leading (driving) the sales process; Demonstrating Passion; and Utilizing ‘Impact Selling’. Therefore, using a customized report, a subject can be specifically evaluated with respect to a specific subject areas, such as sales, to determine the subject's relative weaknesses and strengths in that area. Although a sales model is described herein and in FIG. 3, it is noted that reports can be customized for any suitable subject matter, such as leadership, teams, etc., if desired.

The report information is also stored by the system 100 for later reference or use with global reports and/or analysis regarding subjects, groups of subjects, or even organizations. The reports provided by the report module 140 may take any suitable format and may even be customized by the subject 180. Reports can be made by the report module 140 via a display and/or hard copy, or the like.

Other embodiments exist. For example, an embodiment of the present invention system and method could be used to determine what activities/careers/organizations best suit a particular subject (versus testing the subject based upon a specific area of interest (sales)). In such an embodiment, the subject would be provided with queries/statements directed to a wide range of topics and issues. The responses provided would then be analyzed against a series of available profiles of traits associated with various activities/careers/organizations to see where the best “match” appears. Such information could be used to provide career counseling, employment decisions, marriage counseling, etc.

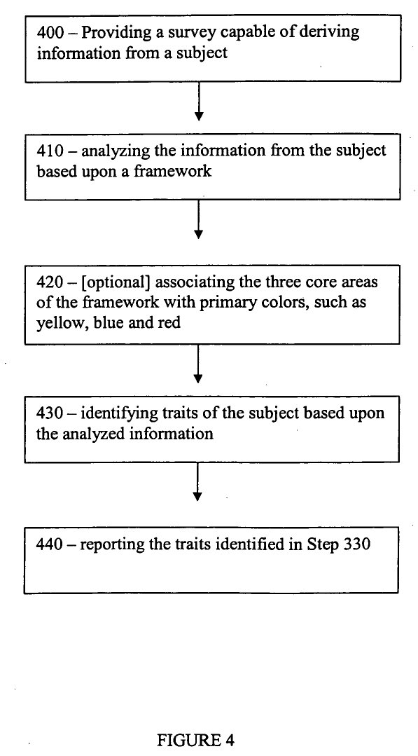

Now turning to FIG. 4, there is shown a flow chart illustrating the steps of the present invention method. In step 400, a subject is provided with a survey capable of deriving information from that subject. The content and format of the survey can be any suitable content (e.g., subject matter, graphics) and format (e.g., rank of affinity, direct queries, etc. . . ) that derives information from the subject. In step 410, the method analyzing the information from the subject is based upon a framework. In a preferred embodiment, the framework comprises three core areas: ideas (thinking); emotions (feeling); and actions (doing). The present invention is premised in part on the discovery that all subjects derive traits from one of these three core areas. Next, in step 420, an optional step is presented where the system of the present invention associates the three core areas with three primary colors. In step 430, the system of the present invention identifies traits of the subject based upon the analyzed information. Finally, in step 440, the traits identified are reported, for example, to the subject. The report can take any desirable format and can be presented in any suitable display medium and/or via any display device. As an example, the report can include content like written trait analysis and descriptions, as well as colored charts to demonstrate same. The report can be provided via a video display associated with a computer and/or communication means and/or printed off as a hard copy for future reference and use.

A number of embodiments of the invention have been described. Nevertheless, it will be understood that various modifications may be made without departing from the spirit and scope of the invention. Accordingly, other embodiments are within the scope of the following claims.

1. A system for human personal and organizational trait analysis of a subject, comprising:
a survey module designed to derive information from the subject;
an analysis module capable of analyzing the information derived from the subject;
a framework capable of revealing traits of the subject based upon the analysis of the information derived from the subject; and
a reporting module.

2. The system of claim 1, wherein the framework comprises three core areas: thoughts, emotions and actions.

3. The system of claim 1, wherein the subject is a human or an organization.

4. The system of claim 1, wherein the survey module uses a set of inquiries to derive the information from the subject, said subject providing answers to the set of inquiries.

5. The system of claim 1, wherein the survey module uses a set of statements to derive the information from the subject, said subject indicating a range of affinity to the set of statements.

6. The system of claim 1, wherein the analysis module analyzes information derived from the subject based upon the framework.

7. The system of claim 1, wherein the report module is capable of generating customized reports about the subject based upon a predetermined subject matter, such as sales, teaming and leadership.

8. The system of claim 2, wherein the framework associates the core areas with three primary colors, such as yellow, blue and red.

9. The system of claim 8, wherein the analysis module identifies traits of the subject based upon the primary colors associated with the core areas.

10. The system of claim 8, wherein the analysis module further identifies traits of the subject based upon secondary colors suggested by blending of the primary colors.

11. A method for human personal and organizational trait analysis of a subject, comprising the steps of:
providing a survey capable of deriving information from the subject;
analyzing the information from the subject based upon a framework;
identifying traits of the subject based upon the analyzed information; and
reporting the traits identified.

12. The method of claim 11, wherein the subject is a human person or an organization.

13. The method of claim 11, wherein the framework comprises three core areas: thoughts, emotions and actions.

14. The method of claim 13, wherein the survey comprises a list of inquiries to which the subject indicates an answer.

15. The method of claim 13, wherein the survey comprises a list of statements to which the subject indicates a range of affinity.

16. The method of claim 13, further including the step of associating the three core areas with primary colors, such as yellow, blue and red.

17. The method of claim 16, wherein the step of identifying traits of the subject further includes the step of identifying traits of the subject based upon the primary colors.

18. The method of claim 17, wherein the step of identifying traits of the subject based upon the primary colors further includes the step of identifying gifts of the subject via one or more secondary colors produced from blending of the primary colors.

19. The method of claim 17, wherein the step of reporting the traits identified includes identifying the traits and the associated primary color(s).

20. The method of claim 18, wherein the step of reporting the traits identified includes identifying the traits, the gifts and the associated primary color(s) and secondary color(s).
